(19) United States
(12) Patent Application Publication
(10) Pub. No.: US 2002/0081996 A1
(43) Pub. Date: Jun. 27, 2002

(54) Method for providing information for subscribers in a network, and an appropriate network system

(76) Inventors: Gero Baese, Muenchen (DE); Martin Gebler, Pulach im Isartal (DE); Sabine Markgraf, Gauting (DE); Annette Schlossnikel, Muenchen (DE); Thomas Strobel, Gauting (DE); Juergen Wilde, Taufkirchen (DE); Andre Fischer, Berlin (DE); Peter Moritz, Haar (DE); Stefan Prange, Muenchen (DE); Arnd Sibila, Moorenweis (DE); Christian Von Brockdorff, Icking (DE)

Correspondence Address: Kevin R. Spivak, Morrison & Foerster LLP, 2000 Pennsylvania Ave., N.W., Washington, DC, 20006-1888, US

(21) Appl. No.: 09/962,600

(22) Filed: Sep. 26, 2001

(30) Foreign Application Priority Data
Sep. 26, 2000 (DE) 10047597.3
Mar. 26, 2001 (DE) 10115745.2

(51) Int. Cl. H04M 11/10

(52) U.S. Cl. 455/412; 455/414

(57) ABSTRACT

The present invention relates to a method for providing individualized information from a total quantity of information for at least one subscriber in a network. A total quantity of information is transmitted to the at least one subscriber in the network, the total quantity of information is made accessible to the at least one subscriber in the network, application software and/or hardware is provided for the at least one subscriber in the network for the purpose of individually selecting and storing information from the total quantity of information. In addition, a network system for providing individualized information from a total quantity of information for at least one subscriber in the network system, and an appropriate communication terminal is provided.

### CLAIM FOR PRIORITY

This application claims priority to German Application Nos. 10047597.3 and 10115745.2 which were published in the German language on Sept. 26, 2000 and Mar. 26, 2001, respectively, the contents of which are hereby incorporated by reference.

### TECHNICAL FIELD OF THE INVENTION

The present invention relates to a method for providing information for subscribers in a network and to a network system for implementing the method.

### BACKGROUND OF THE INVENTION

With the increasingly rising flood of information, whether in written form, such as newspapers or magazines, or other media, such as television, radio or the Internet, it is very difficult for an individual user to comprehend all of this information. The wealth of information, which covers a wide variety of areas, means that filtering out the information which is fundamental to and of interest cannot be quickly and easily accomplished. Before the user fins the information he/she is in search of, he/she has to sift through a great deal of information which is of no significance to him/her. This results in unprodcutive use of time, and may also reduce the user's pleasure in being constantly informed.

### SUMMARY OF THE INVENTION

In one embodiment of the invention, there is a method for providing information from a total amount of information for at least one subscriber in a network. The moethod includes, for example, transmitting the total amount of information to the at least one subscriber in the network, enabling access to the at least one subscriber the total amount of information in the network, and providing application software and/or hardware to the at least one subscriber in the network to select and store information from the total amount of information.

In another aspect of the invention, the total amount of information is transmitted in by broadcasting.

In another aspect of the invention, the total amount of information is transmitted via at least one of a satellite television channel and a terrestrial digital television channel.

In yet another aspect of the invention, the method includes supplying individually selected information from the total amount of information to at least one subscriber at the request of the subscriber.

In another aspect of the invention, the total amount of information is made accessible to a selection of subscribers in the network.

In another aspect of the invention, the suitable piece of application software and/or hardware is provided for a selection of subscribers in the network.

In another embodiment of the invention, there is a network system for providing individualized information from a total amount of information for at least one subscriber in the network system, an information source to provide the total amount of information, a transmission medium to transmit the total amount of information to the at least one subscriber in the network system, a reception unit to receive information for the at least one subscriber in the network, a memory unit to store information for the at least one subscriber in the network system, and a terminal configured for the at least one subscriber in the network system, wherein the at least one terminal for the at least one subscriber has at least one of application software and hardware which the at least one subscriber can use to select information from the total amount of information on an individual basis.

In another aspect of the invention, a selection of subscribers in the network can be selected for whom individualized information from the total amount of information can be provided.

In another aspect of the invention the transmission medium is at least one of a satellite television channel and a terrestrial digital television channel.

In another aspect of the invention, the terminal is a mobile terminal.

In another embodiment of the invention, there is a communication terminal. The terminal includes, for example, at least one of application software and hardware configured to enable a total amount of information from a network accessible and to select information from the total amount of information on an individual basis.

### BRIEF DESCRIPTION OF THE DRAWINGS

Advantages and preferred embodiments of the invention are illustrated with reference to the figure below, in which:

FIG. 1 illustrates an embodiment of a network system.

### DETAILED DESCRIPTION OF THE PREFERRED EMBODIMENTS

The invention provides a method which allows individualized information to be provided from a total quantity of information, i.e. allows a person to be supplied only with the information which he/she has chosen and is of interest to him/her, in order to counteract or prevent an overflow of information.

In one embodiment, the invention presents a method for providing individualized information from a total quantity of information for at least one subscriber in a network, the method comprising:

the total quantity of information is transmitted to the at least one subscriber in the network;

the total quantity of information is made accessible to the at least one subscriber in the network;

a suitable piece of application software and/or hardware is provided for the at least one subscriber in the network for the purpose of individually selecting and storing information from the total quantity of information.

Conventionally, it was possible to personalize or individualize information only on the basis of very broad classifications. In this context, the broad classification was generally performed in a central station, where a profile needed to be created and stored for each subscriber. On account of the large number of subscribers and the associated high level of administration complexity, this centrally stored subscriber profile can be set only very broadly and can in no way be changed dynamically. On the basis of this broadly personalized profile, the central station filtered the available information and transmitted the “personalized” information, which was therefore reduced in scope, to each subscriber (on a point-to-point basis) individually. Even in the case of television, for example, information is personalized by a subscriber only broadly, namely by individually changing over or selecting between otherwise ready-made programs. The programs, on the other hand, are not suited to the specific desires of a subscriber. In this respect, it is not possible to refer to personalization within the context of the invention in this case either. Personalization within the context of the present invention means that the content or information desired by a subscriber and personally tailored to the subscriber is transmitted to or provided for him/her.

Preferably, the full content or information to be made available is gathered by a specifically provided unit in the network, preferably by a service provider, or is bought up by various media companies, publishers or agencies.

According to the invention, the full content or information, for example the full daily press or all the magazines, is transmitted to at least one subscriber, preferably to a plurality of subscribers, in a network by the service provider, for example in a few minutes overnight.

In one preferred embodiment of the invention, the total quantity of information is transmitted by broadcasting, i.e. by transmitting the data on air. This means that it is possible to transmit a very large volume of data quickly and with efficient use of the spectrum.

Preferably, the transmission or broadcasting is effected using a satellite television channel (DvB-S), preferably leased by the service provider, or using a terrestrial digital television channel (DVB-T), preferably likewise leased by the service provider.

According to the invention, the information is made accessible to at least one subscriber in the network to whom the total quantity of information is transmitted, i.e. he/she can receive the data and can also retrieve it as appropriate, for example using a suitable communication terminal or display unit. In this regard, a computer, a mobile radio appliance or a different mobile communication terminal, such as a laptop or a SIMPAD, may be used.

According to the invention, application software and/or hardware is used to allow at least one subscriber in the network to select and store information from the total quantity of information on an individual basis, and preferably also to print it on a compatible printer. In this case, the selection of information from the total quantity of information can be changed by the subscriber at any time, including totally dynamically. The total quantity of information can be stored as full “unprocessed information” and can then be processed, although this requires a large amount of memory space. Alternatively, it can be filtered “on the fly”, i.e. during the actual operation of transmitting it, so that the personalized information, preferably with information beside it for potential demand, is stored and processed as appropriate, i.e. is printed or is loaded onto a suitable communication terminal or display unit.

The information from a total quantity of information can be individualized in various ways. First, the subscriber in the network can individualize the content, i.e. he/she can make the selection on the basis of subject areas, such as sports, economy, stocks and shares, culture, arts, gossip or advertisements. It is also possible to make the subject-area based selection even more specific, for example to select specifically only information relating to the Neuer Markt in Frankfurt, only information specific to Formula 1 or only economic information relating to communications technology. In addition, the invention allows the subscriber in the network to determine the form of presentation for the information which he/she has selected or the level of detail on which information is to be presented. He/She can decide to have only headings or only headings with the first paragraph or complete articles displayed.

In one preferred embodiment of the inventive method, the method comprises:

individually selected additional information from the total quantity of information is supplied to a subscriber subsequently at the request of this subscriber.

If a subscriber in the network has requested that the form of presentation is, by way of example, only headings from the subject areas which he/she has selected, it is possible to supply the complete article subsequently on request. This saves the subscriber from an unnecessary flood of information. He/She can obtain a very quick overview of the subjects which are of interest to him/her by means of headings or abstracts, and if appropriate, can go into one or other subject in more depth by requesting the complete article. This has the benefit of saving time for the subscriber. He/She is also able to concentrate exclusively on information which he considers relevant.

In another preferred embodiment of the invention, the information is made accessible to a stipulated selection of subscribers in the network. Preferably, a selection of subscribers in the network are provided with application software and/or hardware for individually selecting and storing information from the total quantity of information. Hence, a subscriber in the network who wants to make use of a portion of the information needs to register for this service, i.e. he/she needs to be appropriately “subscribed” to this service. He/She is then given access to the information and is given application software and/or hardware which is compatible with his/her particular terminal, for example with his/her mobile radio appliance, laptop or SIMPAD. The terminal can then be used to select, store and display and/or print information from the information on an individual basis. This preferred embodiment of the inventive method provides the unit in the network, i.e. the service provider gathering and/or buying the information from various publishers, agencies and publicists. The provider is given the option of using this to redistribute his incurred costs selectively to the subscribers registered for this service in the network and, in addition, of charging fees for providing this service on a specific basis. Additionally, the service of the invention can be used to distinguish the service provider by use of advertising.

Another object of the present invention is to provide a network system which is suitable for implementing the inventive method.

In one embodiment of the invention, there is a network system for providing individualized information from the totoal amount of information for at least one subscriber in the network system, the network system comprising:

an information source for providing the total quantity of information,

a transmission medium for transmitting the total quantity of information to the at least one subscriber in the network system,

a reception unit for the at least one subscriber in the network system to receive information,

a memory unit for the at least one subscriber in the network system to store information,

a terminal for the at least one subscriber in the network system, where

the terminal(s) for the subscriber(s) in the network system has an application software and/or hardware which the subscriber(s) in the network system can use to select information from the total quantity of information on an individual basis.

The information source is preferably a service provider compiling the total amountt of information by gathering information from various providers, i.e. for example from publishers, agencies and publicists. The service provider buys or collects the information, for example, and broadcasts it via a satellite television channel (DVB-S) and/or terrestrial digital television channel (DVB-T), for example, which it has preferably leased.

In a preferred embodiment, registration with the service provider (which the subscribers in the network need to do, i.e. by appropriate subscription) allows a selection of subscribers in the network to be selected for whom individualized information from the total amount of information can be provided. The service provider thus has a selected target group from which it can demand appropriate charges for providing the service.

The transmission medium is preferably a satellite television channel (DVB-S) and/or a terrestrial television channel (DVB-T). Broadcasting can be used to transmit a very large volume of data, i.e. of information, in a relatively short time period with very efficient use of the spectrum.

The reception unit used may, by way of example, be a DVB antenna located with the subscriber. In one preferred embodiment of the invention, the terminal is a mobile terminal. In this case, the subscriber in the network who is registered for the service can at any time, i.e. even on trips, retrieve information which he/she wants and selects from the total amount of information. Mobile terminals may include, among other things, mobile radio appliances, laptops and SIMPADs.

The selected information can be printed using a compatible printer unit. This can be done immediately or after the registered subscriber in the network has looked through the selected information.

The invention also relates to a communication terminal, preferably a mobile communication terminal, which has a piece of application software and/or hardware which can be used to make a total amount of information from an accessible network, and to select information from the total amount of information on an individual basis. The application software and/or hardware may be a “digital video broadcast plug-in card”, for example, in the case of a piece of hardware.

An advantage of the present invention is that an online copy of, for example, each individual newspaper is not provided. Rather, news, articles, commentary from various newspapers, magazines and from other information providers is provided. From this information, a subscriber in the network can compile the information he/she wants himself/herself on the basis of content and can likewise furnish himself/herslef with it in a format of choice. The ability to select a format enables the subscriber to change the format of “publication” for the particular situation. For example, for people whose profession requires receipt of information in specific areas quickly and spontaneously, the invention affords considerable advantages. The invention also provides advantages for private subscribers.

The invention allows spontaneous plans to be made for the evening or the weekend quickly and easily. By way of example, on finding a suitable event, it is also possible to reserve or request relevant tickets immediately online. The opportunity for individual information which the invention provides also gives the subscriber more motivation to take part in daily events. The effort of continually searching through a flood of information for information which is actually of interest to the individual often results in a kind of lethargy in the subscribers with regard to informing themselves. The subscriber then often prefers to do without any information. By contrast, the invention significantly increases the individual persons' interest again.

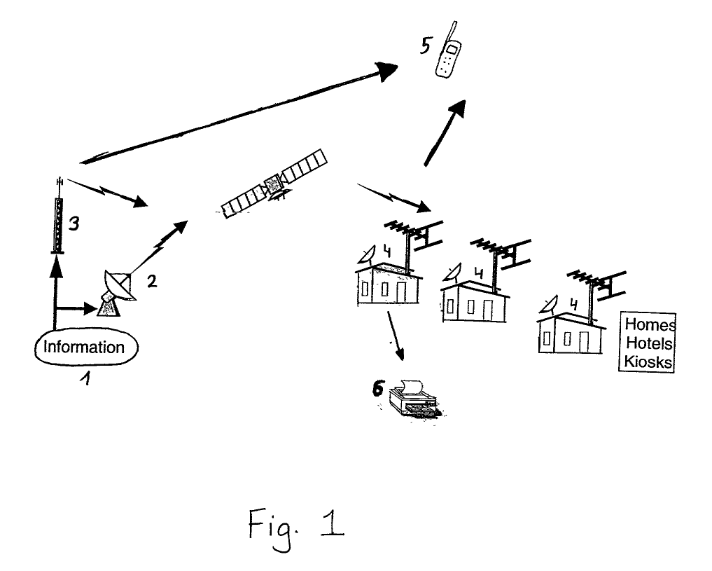

FIG. 1 illustrates of a network system which can be used to implement the inventive method for providing individualized information from a total quantity of information. The service provider 1 gathers or buys information from various providers, such as from publishers, agencies or publicists. The service provider 1 makes this total amount of information (“information”) formed in this way available by broadcast, preferably in a few minutes overnight, i.e. in approximately 30 to 60 minutes. For transmission, the service provider 1 preferably uses a satellite television channel 2 (DVB-S) and/or a terrestrial digital television channel 3 (DVB-T). This type of information transmission is very efficient and is relatively fast. The network subscribers 4 registered for the service have access to the transmitted information data and can use an application software and/or hardware incorporated in their terminal to individualize the information from the total amount of information. The degree of individualization can be changed at any time and also relatively dynamically by the subscribers 4 in the network. The total amount of information can be stored in full and filtered subsequently on the basis of the desired individualization. This, however, requires a large amount of memory space, or it can actually be filtered during the operation of transmitting it. The individualized information filtered in this way can then be loaded directly onto a mobile terminal 5, such as a mobile radio appliance, a SIMPAD or a laptop, and displayed and/or printed on a suitable printing unit 6.

What is claimed is:

1. A method for providing information from a total amount of information for at least one subscriber in a network, comprising:
transmitting the total amount of information to the at least one subscriber in the network;
enabling access to the at least one subscriber the total amount of information in the network; and
providing application software and/or hardware to the at least one subscriber in the network to select and store information from the total amount of information.

2. The method as claimed in claim 1, wherein the total amount of information is transmitted in by broadcasting.

3. The method as claimed in claim 1, the total amount of information is transmitted via at least one of a satellite television channel and a terrestrial digital television channel.

4. The method as claimed in claim 1, further comprising:
supplying individually selected information from the total amount of information to at least one subscriber at the request of the subscriber.

5. The method as claimed in claim 1, wherein the total amount of information is made accessible to a selection of subscribers in the network.

6. The method as claimed in claim 1, wherein the suitable piece of application software and/or hardware is provided for a selection of subscribers in the network.

7. A network system for providing individualized information from a total amount of information for at least one subscriber in the network system, comprising:
an information source to provide the total amount of information;
a transmission medium to transmit the total amount of information to the at least one subscriber in the network system;
a reception unit to receive information for the at least one subscriber in the network;
a memory unit to store information for the at least one subscriber in the network system; and
a terminal configured for the at least one subscriber in the network system, wherein
the at least one terminal for the at least one subscriber has at least one of application software and hardware which the at least one subscriber can use to select information from the total amount of information on an individual basis.

8. The network system as claimed in claim 7, wherein a selection of subscribers in the network can be selected for whom individualized information from the total amount of information can be provided.

9. The network system as claimed in claim 7, wherein the transmission medium is at least one of a satellite television channel and a terrestrial digital television channel.

10. The network system as claimed in claim 7, wherein the terminal is a mobile terminal.

11. A communication terminal, comprising:
at least one of application software and hardware configured to enable a total amount of information from a network accessible and to select information from the total amount of information on an individual basis.
